(19) United States
(12) Patent Application Publication
(10) Pub. No.: US 2025/0337143 A1
(43) Pub. Date: Oct. 30, 2025

(54) INJECTION HOLE SEALING STRUCTURE, BATTERY AND SECONDARY INJECTION METHOD

(71) Applicants: MICROVAST POWER SYSTEMS CO., LTD., Huzhou (CN); MICROVAST, INC., Stafford, TX (US)

(72) Inventors: Guoyou DENG, Huzhou (CN); Xiaojie SHEN, Huzhou (CN); Caihui SHI, Huzhou (CN); Xiaohe LI, Huzhou (CN); Chao LI, Huzhou (CN)

(21) Appl. No.: 18/810,572

(22) Filed: Aug. 21, 2024

(30) Foreign Application Priority Data
Apr. 24, 2024 (CN) 202410495853.0
Apr. 24, 2024 (CN) 202420859060.8

(51) Int. Cl. H01M 50/636

(52) U.S. Cl. CPC H01M 50/636

(57) ABSTRACT

An injection hole sealing structure, a battery and a secondary injection method are provided. The injection hole sealing structure includes a sealing member configured to seal an injection hole of a battery, and the sealing piece is integrally connected to a part of the battery. The sealing member includes a force applying portion for applying an external force.

### CROSS-REFERENCE TO RELATED APPLICATIONS

The present disclosure claims priority to Chinese patent application Nos. 202410495853.0, filed on Apr. 24, 2024, and titled “INJECTION HOLE SEALING STRUCTURE, BATTERY AND SECONDARY INJECTION METHOD”, and 202420859060.8, filed on Apr. 24, 2024, and titled “INJECTION HOLE SEALING STRUCTURE AND BATTERY”. The contents of the above identified applications are hereby incorporated herein in their entireties by reference.

### TECHNICAL FIELD

The present disclosure relates to a field of battery technology, and in particular, to an injection hole sealing structure, a battery and a secondary injection method.

### BACKGROUND

With increasing emphasis on the environment, new energy vehicles have experienced rapid development. As a core component of new energy vehicles, power batteries have a significant impact on progress and development of new energy vehicles. Among them, a main problem in a development of power batteries lies in their own safety issues, especially a sealing of injection holes on the power batteries, which is a key to a safety of power batteries. The sealing of the injection hole affects an overall performance of the power battery. If the injection hole is not sealed in place and leakage occurs, it will have a great adverse effect on the power battery.

In a related art, a sealing structure of the injection hole with existing technology is difficult to balance a sealing stability of the injection hole and a convenience of a secondary injection.

### SUMMARY

According to various embodiments of the present disclosure, an injection hole sealing structure is provided.

An injection hole sealing structure includes a sealing member configured to seal the injection hole of a battery. The sealing member is integrally connected to a part of the battery where the injection hole is located. The sealing member includes a force applying portion configured to apply an external force to cause the sealing member to break.

By integrating the sealing member with the part of the battery where the injection hole is located, a strong and reliable seal between the sealing member and the part of the battery where the injection hole is located is established, meeting a sealing stability requirement of the injection hole and minimizing a risk of leakage. Meanwhile, by an arrangement of the force applying portion on the sealing member, it is conducive to breaking the sealing member under an external force, enabling a secondary injection.

In some embodiments, the sealing member and the part of the battery where the injection hole is located are an integral structure which is formed by stamping, hot pressing, welding, or fusion welding.

In some embodiments, the sealing member further includes a connecting portion connected to the force applying portion. The force applying portion is integrally connected to the part of the battery where the injection hole is located through the connecting portion.

In some embodiments, the force applying portion protrudes from the connecting portion.

In some embodiments, the injection hole has an axis and the force applying portion protrudes towards outside or inside of the battery from the connecting portion along the axis of the injection hole.

In some embodiments, a cavity is formed on a side of the force applying portion along the axis of the injection hole. When the force applying portion protrudes towards the outside of the battery from the connecting portion, the cavity is formed by the sealing member protruding towards the outside of the battery. When the force applying portion protrudes towards the inside of the battery from the connecting portion, the cavity is formed by the sealing member protruding towards the inside of the battery.

In some embodiments, the injection hole has an axis, and along the axis of the injection hole, at least a segment of the force applying portion is defined as an exertion segment for cooperation with an external tool. The exertion segment protrudes towards the outside of the battery from the connecting portion, and an outer size of the exertion segment gradually increases towards the outside of the battery from the connecting portion. Alternatively, the exertion segment protrudes towards the inside of the battery from the connecting portion, the cavity is defined at a side of the sealing member towards the outside of the battery, and a part of the cavity is located at the exertion segment An inner size of the exertion segment gradually increases towards the inside of the battery from the connecting portion.

In some embodiments, the force applying portion is provided with a connecting hole with an opening facing outside of the battery, and a hole wall of the connecting hole is provided a threaded structure.

In some embodiments, an outer size of a projection of the force applying portion is less than a diameter of the injection hole along a radial direction of the injection hole.

In some embodiments, the sealing member further includes a connecting portion and a weakened portion. The connecting portion encircles and is connected to the force applying portion, and is integrally connected to the part of the battery where the injection hole is located. The weakened portion is provided on the connecting portion or the force applying portion or at a joint of the connecting portion and the force applying portion, or on both the connecting portion and the force applying portion. The weakened portion is capable of being broken in response to the external force applied to the force applying portion.

In some embodiments, the weakened portion encircles a location where it is placed.

In some embodiments, the injection hole has an axis, along the axis of the injection hole, at least a part of the force applying portion is constructed as an exertion segment. Along a direction towards the exertion segment from the connecting portion, the weakened portion is located on a upstream of the exertion segment.

In some embodiments, a part of the seal member removed after being broken through the weakened portion is defined as a removal portion. The force applying portion protrudes from the connecting portion towards inside of the battery, and/or, the sealing member is integrally connected to the part of the battery where the injection hole is located towards inside of the battery. A maximum outer size of the removal portion along a radial direction of the injection hole is less than or equal to a diameter of the injection hole.

In some embodiments, the injection hole has an axis, and a recessed groove is provided on at least one end of the part of the battery where the injection hole is located along the axis of the injection hole, and a portion of the sealing member is accommodated in the recessed groove.

In some embodiments, the injection hole sealing structure further includes a sealing cover, in which the sealing cover is disposed on one side of the sealing member facing inside of the battery.

In some embodiments, the sealing cover is connected to the part of the battery where the injection hole is located towards the inside of the battery; or, after the seal member being broken, a portion connected to the part of the battery where the injection hole is located is defined as a remaining portion, the sealing cover is connected to the remaining portion, and the sealing cover is configured to cover a broken part of the sealing member.

In some embodiments, one of the part of the battery where the injection hole is located and the sealing cover has a slot, and the other of the part of the battery where the injection hole is located and the sealing cover has a protrusion for engaging the slot. Alternatively, the sealing cover is adhered to the part of the battery where the injection hole is located.

In some embodiments, the part of the battery where the injection hole is located is provided with a first step. The first step is concave towards outside of the battery from the sealing cover. The sealing cover is located on the first step.

The first step is concave towards the outside of the battery from a bottom surface of the part of the battery where the injection hole is located. Alternatively, a second step is provided on a bottom surface of the part of the battery where the injection hole is located, the second step protrudes towards the inside of the battery from the sealing cover, and the first step is concave towards the outside of the battery from a protruding end surface of the second step. The first step and the second step both surround the injection hole, and the second step surrounds the first step.

In some embodiments, the injection hole sealing structure further includes a protective piece. The protective piece is arranged on one side of the sealing member facing outside of the battery.

In some embodiments, the protective piece is connected to the part of the battery where the injection hole is located. Along a direction towards the outside of the battery from the injection hole, when a downstream side of the sealing member is located downstream of the part of the battery where the injection hole is located, a third step is provided downstream of the part of the battery where the injection hole is located, the third step protrudes towards the outside of the battery around the injection hole, a downstream side of the third step is located on the downstream of the sealing member, and the protective piece is disposed on the third step.

In some embodiments, the injection hole sealing structure further includes an anti-adhesive piece, wherein the anti-adhesive piece is disposed between the sealing cover and the sealing member.

The present disclosure further provides a battery. The battery includes a battery shell and a cover plate connected to the battery shell. The battery shell, the cover plate, or both the battery shell and the cover plate are provided with an injection hole, and the injection hole sealing structure is installed at the injection hole.

In some embodiments, the number of the injection hole is at least two, and at least one of the at least two injection holes is installed with the injection hole sealing structure.

The present disclosure further provides a secondary injection method based on the injection hole sealing structure. The secondary injection method includes the following steps:
operating the force applying portion of the injection hole sealing structure to cause the battery to break at the sealing member to form an opening for secondary injection; and
performing a secondary injection on the battery at the opening and sealing the opening after the secondary injection.

Therefore, it is conducive to breaking before the secondary injection, and an operation is more convenient and faster.

In some embodiments, sealing the opening includes:
welding a sealing piece to seal the opening, or inserting a sealing plug into the opening and then riveting to seal the opening.

Details of one or more embodiments of the present disclosure are presented in the following drawings and descriptions. And other features, objectives and advantages of the present disclosure will become apparent from the description, drawings and claims.

### BRIEF DESCRIPTION OF THE DRAWINGS

In order to provide a clearer explanation of technical solutions in embodiments of the present disclosure or traditional technologies, a brief introduction will be given below to the drawings required for use in embodiments or traditional technology description. It is evident that the drawings described below are only some embodiments of the present disclosure. For those skilled in the art, other drawings can be obtained based on these drawings without creative labor.

FIG. 1 is a cross-sectional schematic diagram of an injection hole sealing structure located on an injection hole in an embodiment according to the present disclosure.

FIG. 2 is a cross-sectional schematic diagram of an injection hole sealing structure located on an injection hole in another embodiment according to the present disclosure.

FIG. 3 is a cross-sectional schematic diagram of an injection hole sealing structure in another embodiment according to the present disclosure.

FIG. 4 is a top view of the injection hole sealing structure in FIG. 3.

FIG. 5 is a bottom view of the injection hole sealing structure in FIG. 3.

FIG. 6 is a cross-sectional schematic diagram of an injection hole sealing structure in another embodiment according to the present disclosure.

FIG. 7 is a top view of the injection hole sealing structure in FIG. 6.

FIG. 8 is a bottom view of the injection hole sealing structure in FIG. 6.

FIG. 9 is a cross-sectional schematic diagram of an injection hole sealing structure in another embodiment according to the present disclosure.

FIG. 10 is a cross-sectional schematic diagram of an injection hole sealing structure in another embodiment according to the present disclosure.

FIG. 11 is a cross-sectional schematic diagram of an injection hole sealing structure in another embodiment according to the present disclosure.

FIG. 12 is a cross-sectional schematic diagram of an injection hole sealing structure located on an injection hole in another embodiment according to the present disclosure.

FIG. 13 is a cross-sectional schematic diagram of an injection hole sealing structure located on an injection hole in another embodiment according to the present disclosure.

FIG. 14 is a cross-sectional schematic diagram of an injection hole sealing structure located on an injection hole in another embodiment according to the present disclosure.

FIG. 15 is a schematic diagram of an injection hole sealing structure fitting with an external tool in FIG. 14.

FIG. 16 is a partial enlargement diagram of portion A in FIG. 15.

FIG. 17 is a schematic diagram of sealing structure of the injection hole broken by the external tool in FIG. 15.

FIG. 18 is a cross-sectional schematic diagram of an injection hole sealing structure located on an injection hole in another embodiment according to the present disclosure.

FIG. 19 is a cross-sectional schematic diagram of an injection hole sealing structure located on an injection hole in another embodiment according to the present disclosure.

FIG. 20 is a cross-sectional schematic diagram of an injection hole sealing structure located on an injection hole in another embodiment according to the present disclosure.

FIG. 21 is a cross-sectional schematic diagram of an injection hole sealing structure located on an injection hole in another embodiment according to the present disclosure.

FIG. 22 is a cross-sectional schematic diagram of an injection hole sealing structure located on an injection hole in another embodiment according to the present disclosure.

FIG. 23 is a cross-sectional schematic diagram of an injection hole sealing structure located on an injection hole in another embodiment according to the present disclosure.

FIG. 24 is a cross-sectional schematic diagram of an injection hole sealing structure located on an injection hole in another embodiment according to the present disclosure.

FIG. 25 is a cross-sectional schematic diagram of an injection hole sealing structure located on an injection hole in another embodiment according to the present disclosure.

FIG. 26 is a cross-sectional schematic diagram of an injection hole sealing structure located on an injection hole in another embodiment according to the present disclosure.

FIG. 27 is a cross-sectional schematic diagram of an injection hole sealing structure secondly sealed by a sealing piece after being broken in another embodiment according to the present disclosure.

FIG. 28 is a cross-sectional schematic diagram of an injection hole sealing structure secondly sealed by a sealing plug after being broken in another embodiment according to the present disclosure.

FIG. 29 is a cross-sectional schematic diagram of an injection hole sealing structure cooperating with a cover plate in another embodiment according to the present disclosure.

Reference signs are as follows: 10 represents a sealing member; 11 represents a force applying portion; 12 represents a connecting portion; 13 represents a weakened portion; 20 represents a sealing cover; 30 represents an anti-adhesive piece; 40 represents a protective piece; 100 represents an injection hole sealing structure; 101 represents a rounded corner; 111 represents an exertion segment; 112 represents a cavity; 114 represents a connecting hole; 115 represents a transition part; 131 represents a V-shaped groove; 200 represents an injection hole; 201 represents a recessed groove; 300 represents a cover plate; 301 represents a first step; 302 represents a second step; 303 represents a third step; 304 represents a ring groove; 305 represents a convex ring; 410 represents a sealing piece; 420 represents a sealing plug; 430 represents a sealing ring; 500 represents an expansion tool; 601 represents a slot; 602 represents a protrusion; 1001 represents an opening; 1002 represents a removal portion; 1003 represents a remaining portion; 1101 represents an outer wall; 1102 represents a top wall; 1103 represents a frustum segment; 1104 represents a cylindrical segment; 1121 represents a cavity bottom wall; 1122 represents a cavity side wall; 2011 represents a first platform; 2012 represents a second platform; 3001 represents inside of a cover plate; 3002 represents outside of a cover plate; 2001 represents a first injection hole; and 2002 represents a second injection hole.

### DETAILED DESCRIPTION

In order to make above objectives, features, and advantages of the present disclosure more obvious and understandable, a detailed explanation of the present disclosure will be provided below in combination with drawings. Many specific details are illustrated in the following description to facilitate a thorough understanding of the present disclosure. However, the present disclosure can be implemented in many ways different from the other ways described herein, and those skilled in the art can make similar improvements without departing from the substantial spirit of the present disclosure. Therefore, the present disclosure is not limited by the specific embodiments disclosed below.

It should be noted that, when a component is considered to be “fixed to” or “set on” another component, it can be directly fixed to or set on another component or there may be intervening components at the same time. When a component is considered to be “connected” to another component, it can be directly fixed to or set on another component or there may be intervening components at the same time. The terms “vertical”, “horizontal”, “up”, “down”, “left” and “right” and similar expressions used herein are only for the purpose of illustration and do not represent the only embodiment.

In addition, the terms “first” and “second” are only used to describe the objectives and cannot be understood as indicating or implying relative importance or implying the quantity of indicated technical features. Therefore, the features limited to “first” and “second” can explicitly or implicitly include at least one of the features. In the description of the present disclosure, “multiple” means at least two, such as two, three, or more, unless otherwise defined.

In the present disclosure, unless otherwise specified and defined. The first feature “up” or “down” on the second feature, which means that the first feature may be in direct contact with the second feature, or in indirect contact with the second feature through an intermediate medium. Besides, the first feature is on, above, and up on the second feature, which means that the first feature is directly or diagonally above the second feature, or only indicates that the first feature is horizontally higher than the second feature. The first feature is under, below, and down the second feature, which means that the first feature is directly or diagonally above the second feature, or only indicates that the first feature is horizontally lower than the second feature.

Unless otherwise defined, all technical and scientific terms used herein have same meaning as commonly understood by those skilled in the art of the present disclosure. The terminology used herein in the specification of the present disclosure is only for the purpose of describing specific embodiments, and is not intended to limit the present disclosure. As used herein, the term “or/and” includes any and all combinations of one or more related listed items. The terms “and/or” used in the description of the present disclosure include any and all combinations of one or more related listed items.

In a power battery, a sealing performance of an injection hole is vital for safety problem of the power battery. It not only affects overall performance of the power battery during use, and if an injection hole does not seal in place or leaks, but also cause adverse effects on the power battery, a safety risk will be high. In a related art, a structure for sealing the injection hole is difficulty to balance a sealing stability on the injection hole and a convenience of a secondary injection.

In some embodiments of the present disclosure, an injection hole sealing structure 100 is provided, which is capable of ensuring sealing stability at an injection hole, and is conducive to breaking for the secondary injection, thereby simplifying procedures of sealing and opening, and an operation is more convenient. There is a detailed description below of the injection hole sealing structure 100.

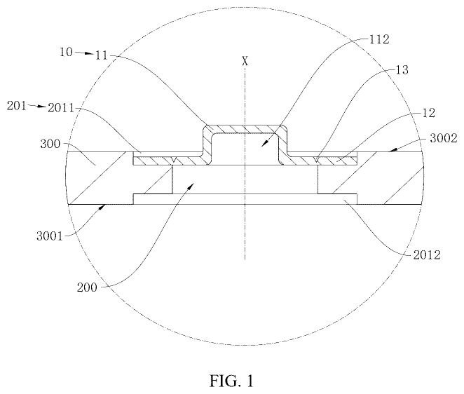

Referring to FIGS. 1 to 3, in some embodiments, an injection hole sealing structure 100 includes a sealing member 10 configured to seal an injection hole 200 of a battery. The sealing member 10 is integrally connected to a part of the battery where the injection hole 200 is located. The sealing member 10 includes a force applying portion 11 configured to apply an external force to break. The injection hole 200 is a structure on the battery configured to inject liquid. The injection hole 200 can be provided on a cover plate 300 or a battery shell (not shown). Therefore, a part of the battery where the injection hole 200 is located indicates the cover plate 300 or the battery shell. The battery has a battery cavity configured to accommodate an electrolyte. The injection hole 200 passes through the cover plate 300 or the battery shell to be in communicate with the battery cavity. It can inject the electrolyte into the battery cavity through the injection hole 200. Hereinafter, taking the injection hole 200 being defined on the cover plate 300 as an example, the part of the battery where the injection hole 200 is located is the cover plate 300.

By integrating the sealing member 10 with the cover plate 300, a strong and reliable seal between the sealing member 10 and the cover plate 300 can be ensured, meeting a sealing requirement of the injection hole 200 and minimizing a leakage risk. Meanwhile, by an arrangement of the force applying portion 11, it means that an area configured for an external tool to force is defined on the sealing member 10, which is conducive for the external tool to cooperate with the force applying portion 11 of the sealing member 10, so as to enable the sealing member 10 to be broken under an external force and enable a secondary injection. In addition, since the sealing member 10 is integrally connected to the cover plate 300, whether it is for an initial sealing or a break of the secondary injection, which can be completed once, an operation is simpler and more convenient, and procedures of sealing and opening are simplified. In particular, when the injection hole 200 is defined on the battery shell, the sealing member 10 is integrally connected to the battery shell.

The above integrated connection indicates an integrated processing and forming, which belongs to a fixedly connection way. Compared with a split connection (such as a detachable connection), the integrated connection does not require a clearance configured for cooperation. Therefore, the sealing performance is better and the operation is more convenient and faster.

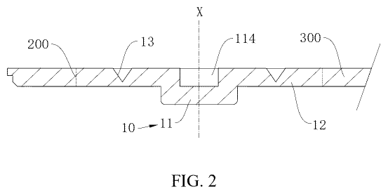

Referring to FIG. 2, in some embodiments, the sealing member 10 is integrally connected to the cover plate 300 by stamping, hot pressing, or other method. The cover plate 300 can be covered on an opening of the battery shell after injecting a liquid, and the battery is sealed. As shown in FIG. 1, alternatively, when the cover plate 300 and the sealing member 10 are made of metal material, the sealing member 10 is integrally connected to the cover plate 300 by welding. Alternatively, the sealing member 10 is integrally connected to the cover plate 300 by fusion welding, and the sealing member 10 can be made of plastic, resin, and so on.

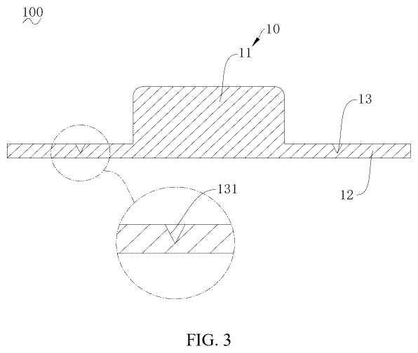

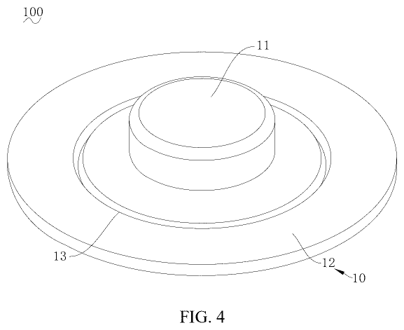

Referring to FIGS. 3 to 5, alternatively, the force applying portion 11 can be a solid structure to ensure a higher strength, and a stronger connection with the external tool.

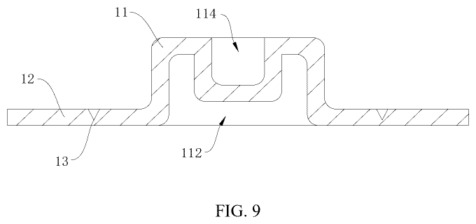

Referring to FIGS. 2 and 9, alternatively, the force applying portion 11 can be provided with a connecting hole 114, and a hole of the connection hole 114 is provided towards outside of the battery, which is conducive to connecting a hole wall of the connecting hole 114 by the external tool to drive the force applying portion 11 to break the sealing member 10. In particular, it can form a threaded structure in a hole wall of the connecting hole 114 as a thread hole, which is conducive to connecting to the force applying portion 11 by a screw rod or a screw, and to breaking. Alternatively, a first protrusion (not shown in the drawings) can be provided in the hole wall of the connecting hole 114, an external tool with a first groove is configured to be inserted into the connecting hole 114, which realizes a connection between the external tool and the force applying portion 11 by a fit between the first protrusion and the first groove.

Referring to FIG. 3, in actual use, when the force applying portion 11 protrudes towards outside of the battery, the external tool can clamp an external part of the force applying portion 11, and pull the force applying portion 11 towards the outside of the battery, so as to break the sealing member 10. The force applying portion 11 having a solid structure is more conducive to bearing a clamping force applied by the external tool, thereby ensuring a clamping stability.

Referring to FIGS. 1 and 2, in some embodiments, the sealing member 10 further includes a connecting portion 12. The connecting portion 12 is connected to the force applying portion 11, and the force applying portion 11 is integrally connected to the cover plate 300 through the connecting portion 12.

In other words, by an arrangement of the connecting portion 12, it can realize that the sealing member 10 is integrally connected to the cover plate 300, which is conducive to distinguishing a connection part of the sealing member 10 from a breaking force applying part of the sealing member 10. It can meet a requirement of the sealing performance, and can prevent from causing an interference or damage for an edge or a hole wall of the injection hole 200 during the break. The force applying portion 11 is connected to the connecting portion 12 along circumference of the force applying portion 11, so as to totally ensure that the sealing member 10 is reliably connected to the cover plate 300, and a sealing effect is better.

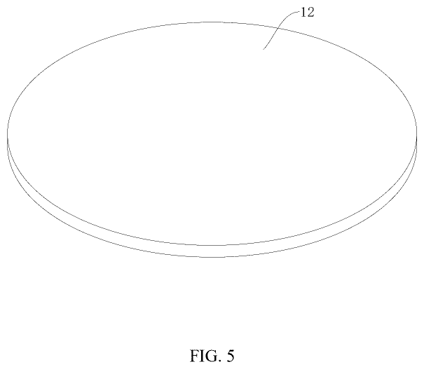

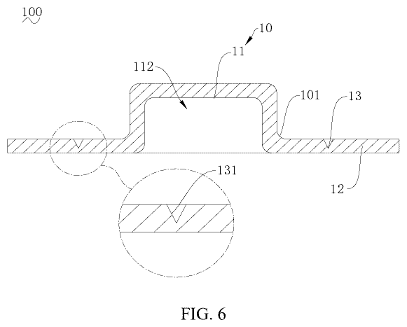

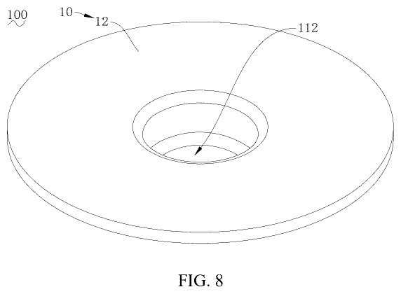

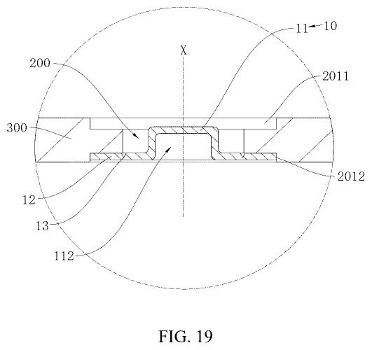

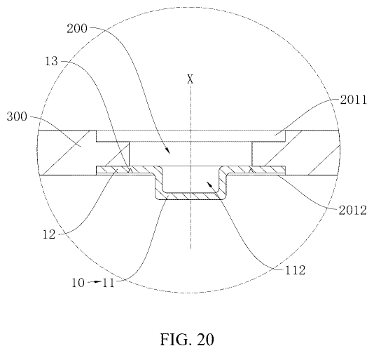

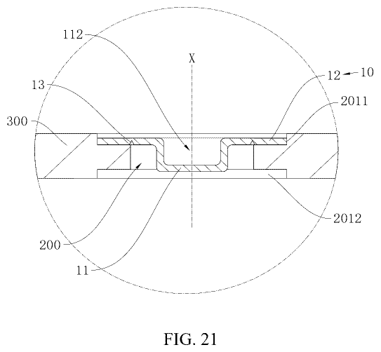

Referring to FIGS. 6 to 21, in some embodiments, the connecting portion 12 encircles outer circumference side of the force applying portion 11, i.e., the connecting portion 12 is ring-shaped, sleeved on outside of the force applying portion 11, and integrally connected to the force applying portion 11. Therefore, the force applying portion 11 is connected to the connecting portion 12 along the circumference of the force applying portion 11, thereby ensuring an excellent sealing performance. Meanwhile, the force applying portion 11 can be a force applying point of the external tool and can be configured to seal the injection hole 200. Alternatively, the connecting portion 12 is plate-shaped (shown in FIG. 5), and the force applying portion 11 is connected to a side of the connecting portion 12 towards the outside of the battery. Meanwhile, the connecting portion 12 is configured to be integrally connected to a part of the battery where the injection hole 200 is located and seal the injection hole 200. The force applying portion 11 is merely regarded as a force applying area for cooperation with the external tool.

In some embodiments, the force applying portion 11 is integrally connected to the connecting portion 12, thereby improving structure strength of the sealing member 10, ensuring the sealing performance, simplifying procedures, and reducing a cost. For example, the force applying portion 11 is integrally connected to the connecting portion 12 by stamping or hot pressing, or other method.

Referring to FIGS. 1, 2 and 12 to 21, further, the injection hole 200 has an axis. Along the axis of the injection hole 200, an edge of a projection of the injection hole 200 falls in an edge of a projection of the connecting portion 12.

Referring to FIGS. 1 and 12 to 21, when the connecting portion 12 is integrally connected to the cover plate 300 by welding or fusion welding, along the axis of the injection hole 200, the edge of the projection of the connecting portion 12 falls out of the edge of projection of the injection hole 200, so as to ensure that the connecting portion 12 and the cover plate 300 have a sufficient cooperation area and a sealing area, thereby ensuring a connection reliability and the sealing performance. Referring to FIG. 2, when the connecting portion 12 is integrally connected the cover plate 300 by stamping or hot pressing, the edge of the projection of the injection hole 200 coincides with the edge of the projection of the connecting portion 12. In other words, when the edge of the injection hole 200 falls in the edge of the projection of the connecting portion 12, there are two situations including that the edge of the injection hole 200 coincides with the connecting portion 12 and the edge of the connecting portion 12 falls out of the edge of the projection of the injection hole 200.

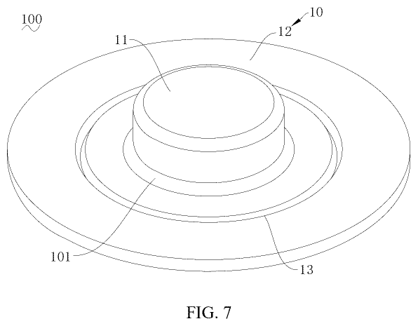

Referring to FIGS. 1 to 26, exemplary, the force applying portion 11 protrudes from the connecting portion 12, which ensures a sufficient force applying space and is conducive to using the external tool applying to the force applying portion 11 to break the sealing member 10 for the secondary injection. Referring to FIGS. 6 and 7, a rounded corner 101 is provided on a joint of the force applying portion 11 and the connecting portion 12 to reduce a stress concentration.

Referring to FIGS. 1, 3, 4, 6, 7, 9 to 13 and 19, in particular, the force applying portion 11 protrudes towards the outside of the battery from the connecting portion 12 along the axis of the injection hole 200. Such arrangement is more conducive for the external tool to operate, especially when the sealing member 10 is installed on a side of the cover plate 300 towards the outside of the battery (i.e., outside 3002 of the cover plate 300 hereinafter), and the force applying portion 11 related to the cover plate 300 is under a state of protruding towards the outside of the battery, which is capable of reducing a possibility that the injection hole 200 interferes with the external tool.

Referring to FIGS. 2, 14 to 18 and 20 to 21, alternatively, the force applying portion 11 protrudes towards inside of the battery from the connecting portion 12 along the axis of the injection hole 200. Meanwhile, when the sealing member 10 is integrally connected one side of the cover plate 300 towards the inside of the battery (i.e. inside 3001 of the cover plate 300 hereinafter), the force applying portion 11 will not protrude towards the outside of the battery, so as to prevent from interfering and bumping to damage a sealing component of the sealing member 10, thereby improving a protection.

Referring to FIGS. 1, 12 to 15 and 17 to 21, in some embodiments, a recessed groove 201 is defined on a part of the battery where at least one end of the injection hole 200 along an axis of the injection hole 200 is located, i.e., the recessed groove 201 is defined on at least one side of the cover plate 300 along the axis of the injection hole 200. A part of the sealing member 10 is accommodated in the recessed groove 201. By an arrangement of the recessed groove 201, it is conducive to accommodating the connecting portion 12 in the sealing member 10 and is conducive for locating, installing and connecting of the connecting portion 12. Furthermore, along the axis of the injection hole 200, a depth of the recessed groove 201 is not less than (i.e., greater than or equal to) a thickness of the connecting portion 12, thereby ensuring that the connecting portion 12 does not protrude outside. It prevents the connecting portion 12 from protruding towards the outside of the battery relative to the cover plate 300, which is prone to be bumped to influence a connecting reliability. Alternatively, it prevents the connecting portion 12 from protruding towards the inside of the battery relative to the cover plate 300, which improves an assembly difficulty and reduces a battery power density.

Furthermore, a diameter of the recessed groove 201 is greater than the diameter of the injection hole 200, which ensures an arrangement requirement that the outer diameter of the connecting portion 12 is greater than the diameter of the injection hole 200, while meeting a protection for the connecting portion 12.

In particular, the recessed grooves 201 being defined on two sides of the cover plate 300 along the axis of the injection hole 200 is taken as an example. A first platform 2011 is defined on the outside 3002 of the cover plate 300, and a second platform 2012 is defined on the inside 3001 of the cover plat300. Meanwhile, the sealing member 10 can be connected to one of the first platform 2011 and the second platform 2012, i.e., the connecting portion 12 can be accommodated in the first platform 2011 and integrally connected to the cover plate 300. Alternatively, the connecting portion 12 can be accommodated in the second platform 2012 and integrally connected the cover plate 300. When the connecting portion 12 is accommodated in the second platform 2012, the first platform 2011 can further be configured to assemble the sealing structure after the secondary injection.

In particular, when the sealing member 10 is installed on the first platform 2011 by the connecting portion 12, the force applying portion 11 can protrude towards the outside or the inside of the battery from the connecting portion 12. An assembling way of the sealing member 10 on the second platform 2012 is substantially similar to that on the first platform 2011, which is not limited herein.

Referring to FIGS. 1, 6 to 11 and 14 to 21, in some embodiments, a cavity 112 is defined on one side of the force applying portion 11 along the axis X of the injection hole 200.

When the force applying portion 11 protrudes towards the outside of the battery from the connecting portion 12, the cavity 112 is defined by a side of the sealing member 10 towards inside of the battery (it names inside of the sealing member in following) recessing towards the outside of the battery. Such arrangement means that an opening of the cavity 112 faces the inside of the battery, so that the force applying portion 11 is in a hollow shape, which is conducive to realizing a lightweight design, saving materials and reducing a cost. In some embodiments, the connecting hole 114 can be formed by a side of the force applying portion 11 towards the outside of the battery recessing towards the inside of the battery along the axis X of the injection hole 200 (as shown in FIG. 9).

When the force applying portion 11 protrudes towards the inside of the battery from the connecting portion 12, the cavity 112 is defined by an side of the sealing member 10 towards the outside of the battery (i.e., outside of the sealing member hereinafter) recessing towards the inside of the battery, i.e., an opening of the cavity 112 faces the outside of the battery. Meanwhile, an arrangement of the cavity 112 is conducive to allowing an expandable external tool (expansion tool 500) to insert and abut against a side wall of the cavity 112, and breaking the sealing member 10 by applying pulling force towards the outside of the battery. In addition, since the force applying portion 11 can be tightly inflated on the expansion tool 500 via the cavity 112, it can prevent the force applying portion 11 from falling.

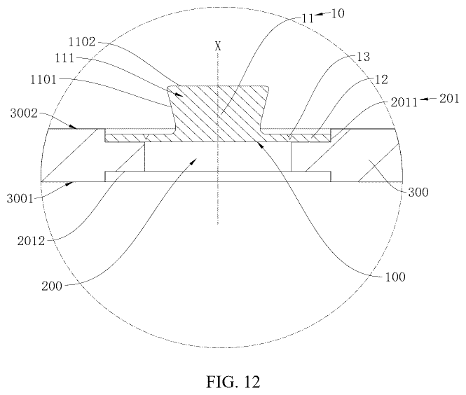

Referring to FIGS. 12 to 18, along the axis of the injection hole 200, an exertion segment 111 configured to cooperate with the external tool is formed on at least a segment of the force applying portion 11, thereby improving a connecting reliability between the force applying portion 11 and the external tool, and preventing the external tool from slipping and detaching from the force applying portion 11 during period of focusing on the exertion segment 111 and pulling outwards.

Referring to FIG. 12, the force applying portion 11 protrudes towards the outside of the battery from the connecting portion 12. In addition, an outer size of the exertion segment 111 gradually increases along a direction towards the outside of the battery from the connecting portion 12. When the force applying portion 11 is provided in a solid shape, the force applying portion 11 includes a top wall 1102 and an outer wall 1101. The top wall 1102 is connected to the outer wall 1101. An acute angle is defined between the top wall 1102 and the outer wall 1101. The top wall 1102 is parallel or trends to parallel to the connecting portion 12, so that the force applying portion 11 is invertedly frustum-shaped. That is, a diameter of the force applying portion 11 gradually increases towards the outside of the battery from the connecting portion 12. Meanwhile, the exertion segment 111 is formed on the force applying portion 11 on the outer wall 1101, which is conducive to abutting against and limiting the external tool. When the external tool clamps in a middle of the force applying portion 11 and pulls towards the outside of the battery, a part of the force applying portion 11 with a relative large diameter abuts against the external tool, so as to prevent the external tool from detaching from the force applying portion 11 as far as possible. In particular, an outer size of the exertion segment 111 is a size defined by the outer wall 1101 of the force applying portion 11.

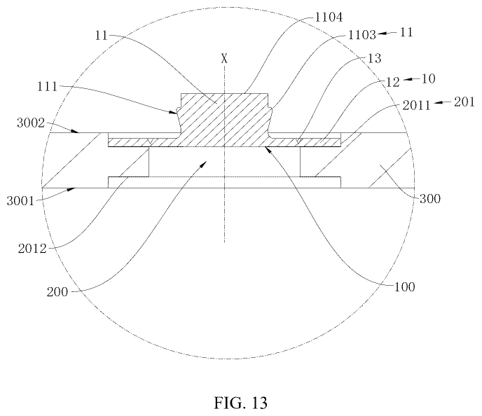

Referring to FIG. 13, in some embodiments, the force applying portion 11 includes an inverted frustum segment 1103 and a cylindrical segment 1104 connecting to the frustum segment 1103. An end of the frustum section 1103 away from the cylindrical segment 1104 is connected to the connecting portion 12. A diameter of the frustum segment 1103 gradually increases towards the outside of the battery from the connecting portion 12. A diameter of the cylindrical segment 1104 is less than or equal to a maximum diameter of the frustum segment 1103. At this time, the frustum segment 1103 can be regarded as the exertion segment 111.

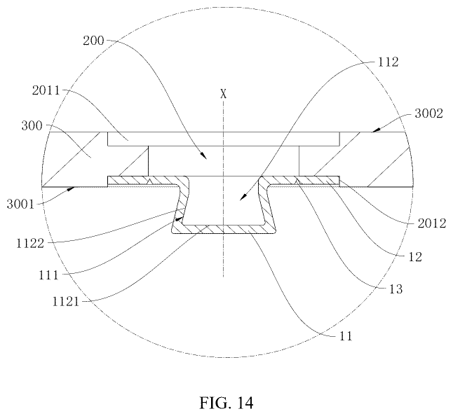

Referring to FIGS. 14 to 17, an expansion tool 500 inflating the force applying portion 11 to break is taken as an example. At this time, the force applying portion 11 protrudes towards the inside of the battery from the connecting portion 12, the cavity 112 is defined on the side of the force applying portion 11 towards the outside of the battery, and the cavity 112 is a concave recessing towards the inside of the battery from the outside of the sealing member along the axis of the injection hole 200. At least a part of the cavity 112 is located on the exertion segment 111. In addition, an inner size of the exertion segment 111 having the cavity 112 gradually increases along a direction towards the inside of the battery from the connecting portion 12. In particular, the cavity 112 includes a cavity bottom wall 1121 and a cavity side wall 1122. An acute angle is defined between the cavity bottom wall 1121 and the cavity side wall 1122. The cavity bottom wall 1121 is parallel to or trends to parallel to the connecting portion 12. The exertion segment 111 is formed on the force applying portion 11 where the cavity side wall 1122 is located, such that an inner size of the exertion segment 111 gradually increases along a direction towards the inside of the battery from the connecting portion 12, which is conducive to abutting against and limiting the expansion tool 500, thereby preventing the expansion tool 500 from detaching from the force applying portion 11. Meanwhile, it can pull the force applying portion 11 towards the outside of the battery to break. In particular, the inner size of the exertion segment 111 is a size defined by the cavity side wall 1122 of the cavity 112.

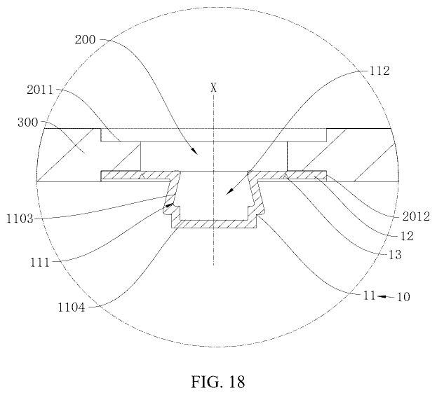

Referring to FIG. 18, the cavity 112 can further include a frustum segment 1103 and a cylindrical segment 1104. An arrangement of the frustum segment 1103 and the cylindrical segment 1104 is similar to that of above, which is not limited herein.

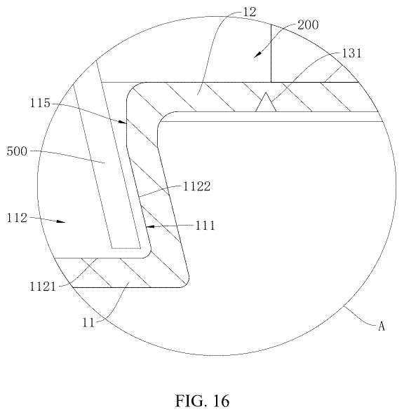

Referring to FIG. 16, a part of the force applying portion 11 located between the exertion segment 111 and the connecting portion 12 is regarded as a transition part 115. An angle of 90° is defined between the transition part 115 and the connecting portion 12, thereby reducing stress concentration of a joint between the force applying portion 11 and the connecting portion 12. If the exertion segment 111 is directly connected to the connecting portion 12, due to a size of the exertion segment 111, it enables the exertion segment 111 and the connecting portion 12 to be arranged with an acute angle therebetween, and the stress concentration problem will be worse. Therefore, it requires the above transition part 115 to buffer.

Referring to FIGS. 1 to 17, alternatively, along the axis of the injection hole 200, a projection of the force applying portion 11 falls in a projection of the injection hole 200. In other words, a maximum outer size of the force applying portion 11 is less than a diameter of the injection hole 200. By such arrangement, when the force applying portion 11 is located in the battery, there is a clearance between the outer wall 1101 of the force applying portion 11 and the hole wall of the injection hole 200, which means that the force applying portion 11 is not in contact with the hole wall of the injection hole 200. Meanwhile, when the force applying portion 11 moves towards the outside of the battery by the external tool, the force applying portion 11 does not obstruct the hole wall of the injection hole 200, thereby reducing a break inhibition and facilitating the breaking process.

Referring to FIGS. 1 to 21, in some embodiments, the sealing member 10 further includes a weakened portion 13. The weakened portion 13 is provided on the connecting portion 12 and/or the force applying portion 11, and is configured to be broken in response to an external force applied to the force applying portion 11. In other words, by an arrangement of the weakened portion 13, it is more conducive to breaking the sealing member 10 by the external tool acting on the force applying portion 11. The weakened portion 13 is regarded as a part of the sealing member 10 reducing the strength of the connecting portion 12 or the force applying portion 11, which is conducive to breaking the weakened portion 13 under the external force, thereby achieving an opening of the injection hole 200 for the secondary injection.

Referring to FIGS. 3, 6 and 16, in some embodiments, it can perform a thinning treatment on a portion of the sealing member 10 to reduce a thickness of the sealing member 10 and to form the weakened portion 13. The weakened portion 13 can be a V-shaped groove 131 on the sealing member 10. Alternatively, the weakened portion 13 can be any shaped groove such as a square groove or trapezoidal groove. Furthermore, the weakened portion 13 can be a tear line or a scratch on the sealing member 10. The weakened portion 13 does not penetrate through the sealing member 10 to ensure a good sealing performance of the sealing member 10, as long as it can ensure that the structure strength of the weakened portion 13 is relative low, which is conducive to being broken by the external force.

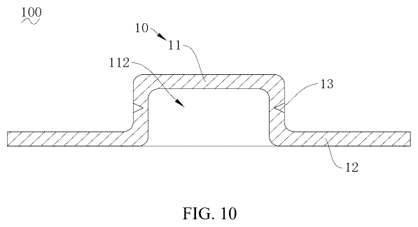

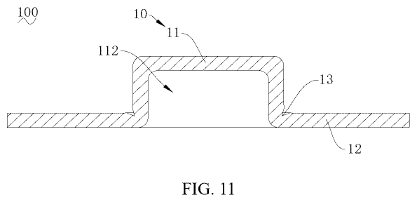

Referring to FIG. 10, the weakened portion 13 is provided on the force applying portion 11. Meanwhile, the weakened portion 13 is located on a middle of the force applying portion 11, or a portion which is adjacent to the connecting portion 12, ensuring a sufficient contact area cooperating with the external tool on an end of the force applying portion 11 away from the connecting portion 12. Referring to FIGS. 3 and 6, alternatively, the weakened portion 13 is provided on the connecting portion 12. Meanwhile, the weakened portion 13 is located upstream of the force applying portion 11, thereby reducing a lever arm of a force applying by the external tool through the force applying portion 11 to the weakened portion 13 as far as possible, which is more conducive to being broken on the weakened portion 13. Referring to FIG. 11, alternatively, the weakened portion 13 is provided at the joint of the connecting portion 12 and the force applying portion 11. Since the force applying portion 11 protrudes from the connecting portion 12, a problem of the stress concentration will occur on the joint of the force applying portion 11 and the connecting portion 12, and the strength of the joint of the force applying portion 11 and the connecting portion 12 will reduce a bit. Therefore, the weakened portion 13 is placed on this joint, facilitating the breaking process and thereby minimizing wear on the wall of the injection hole 200 resulting from the tearing of the connecting portion 12 during breaking.

Alternatively, the weakened portion13 can be each provided on the connecting portion 12 and the force applying portion 11. Meanwhile, the two weakened portions 13 are placed adjacent to each other.

Referring to FIGS. 1 to 4, 6 to 7 and 9 to 21, in some embodiments, the weakened portion 13 encircles a location where it is placed (such as encircles the connecting portion 12, encircles the force applying portion 11 and/or encircles the joint of the connecting portion 12 and the force applying portion 11). That is, the weakened portion 13 is provided in a ring shape and encircles circumference of the location where it is placed. By such arrangement, it can ensure that a portion where the weakened portion 13 is located has an area being broken along circumference of the weakened portion 13, thereby saving labor. When the location where the weakened portion 13 is placed is in a cylindrical shape, the weakened portion 13 can be in a ring shape.

Alternatively, the weakened portion 13 can be in a strip shape, at same time, a plurality of weakened portions 13 can be provided as required, which are arranged at interval along the circumference of the location where it is placed. In some embodiments, the plurality of weakened portions 13 are equally arranged at intervals. If the location where the weakened portion 13 is placed is in a cylinder shape, each weakened portion 13 can be arc-shaped. If the location where the weakened portion 13 is placed is prism-shaped, each weakened portion 13 can be straight-line-shaped.

Referring to FIGS. 14 to 17, optionally, a diameter of the weakened portion 13 is not greater than (i.e., less than or equal to) the diameter of the injection hole 200. Therefore, the phenomenon that the sealing member 10 detaching from the battery can not be taken from the injection hole 200 after breaking can be prevented. Referring to FIGS. 14 to 16, when the V-shaped groove 131 is regarded as the weakened portion 13, at this time, a diameter of the weakened portion 13 is based on a circle corresponding to an intersection position of the V-shaped groove 131.

Referring to FIGS. 12 to 18, alternatively, the weakened portion 13 is provided upstream of the exertion segment 111 along a direction of the connecting portion 12 towards the exertion segment 111. The exertion segment 111 is configured to cooperate with the external tool, if the weakened portion 13 is located downstream of the exertion segment 111, even if the external tool acts on the exertion segment 111 to pull, it will not generate a pulling force for the weakened portion 13. Therefore, the weakened portion 13 should be located upstream of the exertion segment 111, which is conducive to transferring the pulling force applied by the external tool to the weakened portion 13 and facilitates breaking.

In particular, a part of the sealing member 10 removed after breaking through the weakened portion 13 is a removal portion 1002, and a part of the sealing member 10 still connecting to the cover plate 300 after being breaking is a remaining portion 1003. When the force applying portion 11 protrudes towards the inside of the battery from the connecting portion 12, and/or, when the sealing member 10 is integrally connected to the part of the battery where the injection hole 200 is located towards the inside of the battery, a maximum outer size of the removal portion 1002 along a radial direction of the injection hole 200 is not greater than (less than or equal to) a diameter of the injection hole 200. After the sealing member 10 is broken from the weakened portion 13, an opening 1001 is formed and the diameter of the weakened portion 13 is regarded as a diameter of the opening 1001. Since the largest outer size of the removal portion 1002 along the radial direction of the injection hole 200 is not greater than (less than or equal to) the diameter hole of the injection hole 200, it is conducive to taking the removal portion 1002 out from the injection hole 200 after being breaking, so as to prevent the removal portion 1002 from falling in the battery.

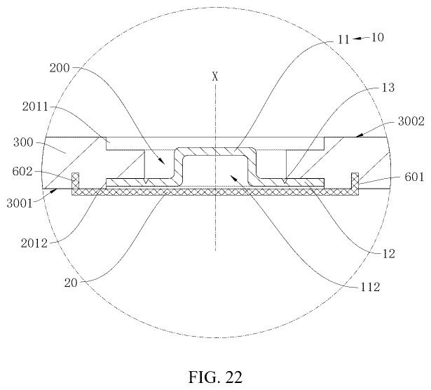

Referring to FIGS. 22 to 26, in some embodiments, the injection hole sealing structure 100 further includes a sealing cover 20, and the sealing cover 20 is disposed on one side of the sealing member 10 towards the inside of the battery. The sealing cover 20 is configured to prevent external substances, such as impurities and water, from falling in the electrolyte during the secondary injection. In particular, when the sealing member 10 is broken to perform the secondary injection, it can use a puncture needle to tear through the sealing cover 20, in which the sealing cover 20 compresses and seals on an outer side wall of the injecting puncture needle. In particular, the sealing cover 20 can be made of materials such as silicone, rubber, or silicone rubber. After the puncture needle is withdrawn, the sealing cover 20 can recover and seal due to deformation characteristic of the puncture needle. Therefore, it can further improve the sealing performance on the injection hole 200 by the sealing cover 20.

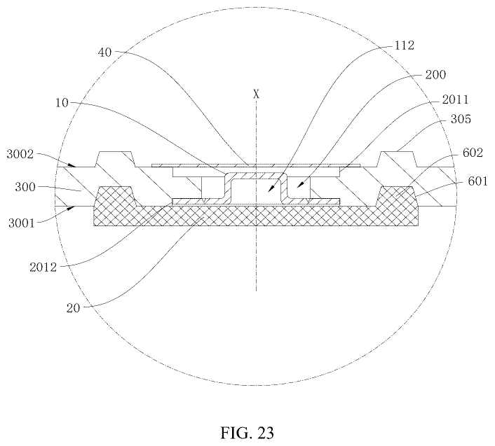

Furthermore, referring to FIGS. 22 and 23, the sealing cover 20 is connected to a side of the cover plate 300 towards the inside of the battery. For example, the sealing cover 20 can be adhered on the inside 3001 of the cover plate 300. Alternatively, a slot 601 is defined on one of a part of the inside 3001 of the cover plate 300 and the sealing cover 20, a protrusion 602 engaging with the slot 601 is defined on the other of the part of the inside 3001 of the cover plate 300 and the sealing cover 20, thereby realizing an assembly by an engagement between the protrusion 602 and the slot 601. Taking the protrusion 602 positioned on the sealing cover 20 as an example, the protrusion 602 can protrude towards the outside of the battery and from the sealing cover 20 along the axis of the injection hole 200, the inside 3001 of the cover plate 300 is concave towards the outside of the battery and is defined with the slot 601, thereby realizing an assembly of the sealing cover 20. In particular, the slot 601 and the protrusion 602 are ring-shaped, so as to ensure the connecting reliably.

In actual use, when the cover plate 300 is stamped, and the inside 3001 of the cover plate 300 is recessed with the slot 601, a portion of the outside 3002 of the cover plate 300 corresponding to the slot 601 forms a convex ring 305 protruding towards the outside of the battery.

Alternatively, the sealing cover 20 is connected to a part of the sealing cover 20 which is still connected to the cover plate 300 after being broken, i.e., the sealing cover 20 is connected to the remaining portion 1003. Meanwhile, the remaining portion 1003 of the sealing member 10 and the sealing cover 20 can realize an assembly by cooperation between the slot 601 and the protrusion 602.

In particular, while completing the assembly between the slot 601 and the protrusion 602, the sealing cover 20 can be adhered on a position where it is placed to improve the connecting stability.

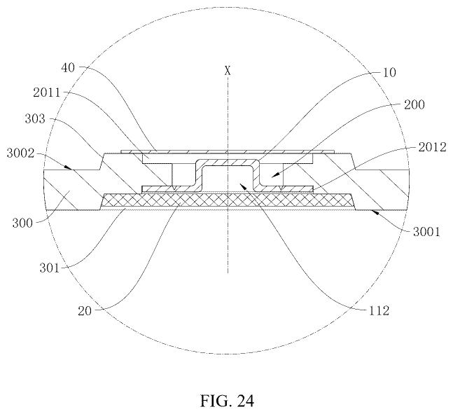

Referring to FIGS. 24 to 27, in some embodiments, a first step 301 is provided by the inside 3001 of the cover plate 300 recessing outwards the battery along the sealing cover 20. The sealing cover 20 is located on the first step 301, thereby improving assembly reliability of the sealing cover 20. When the sealing cover 20 is connected to the remaining portion 1003, a side wall of the remaining portion 1003 towards the inside of the battery recesses outwards of the battery to form the first step 301, so as to realize an assembly of the sealing cover 20 and the remaining portion 1003.

In some embodiments, when the first platform 2011 and the second platform 2012 are provided on two sides of the cover plate 300 along the axis X of the injection hole 200, respectively, if the sealing member 10 is installed on the first platform 2011, the second platform 2012 can be regarded as the first step 301 herein, which is configured to assemble the sealing cover 20. Alternatively, when the sealing member 10 is installed on the second platform 2012, the side wall of the inside 3001 of the cover plate 300 recesses towards the outside of the battery to form a first step 301, and the first step 301 recesses towards the outside of the battery to form a second platform 2012.

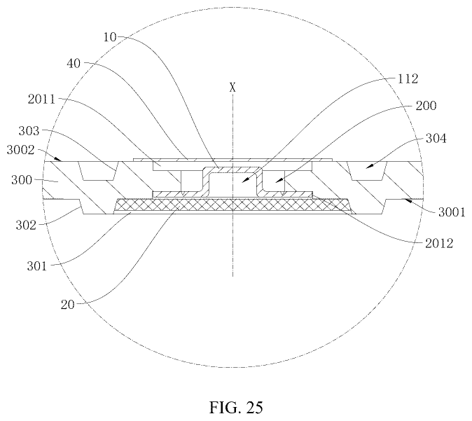

Referring to FIG. 25, in some embodiments, the inside 3001 of the cover plate 300 recesses toward the inside of the battery to form a second step 302 along the sealing cover 20. The end of the second step 302 protruding towards the inside of the battery is defined as a protruding end. The first step 301 recesses towards the outside of the battery from the protruding end of the second step 302. The first step 301 and the second step 302 surround the injection hole 200, and the second step 302 surrounds the first step 301. The sealing cover 20 is accommodated in the first step 301, and the sealing cover 20 is adhered and fixed on the cover plate 300. By such arrangement, when the sealing member 10 is installed on the second platform 2012 of the inside 3001 of the cover plate 300, an arrangement of the second step 302 can prevent a problem that a part of the battery where the injection hole 200 is located is too thin to arrange the second platform 2012 and the first step 301 along the axis X of the injection hole 200 at same time.

In particular, when the second step 302 is integrated by stamping the cover plate 300, and the outside 3002 of the cover plate 300 recesses towards the inside of the battery to form a ring groove 304.

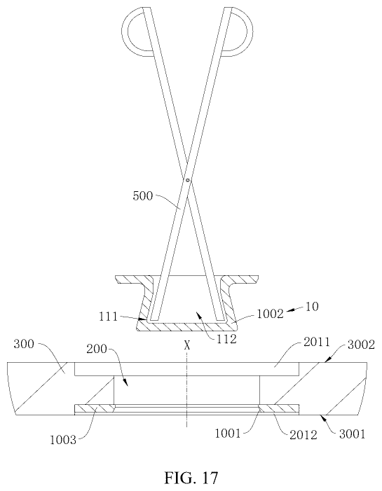

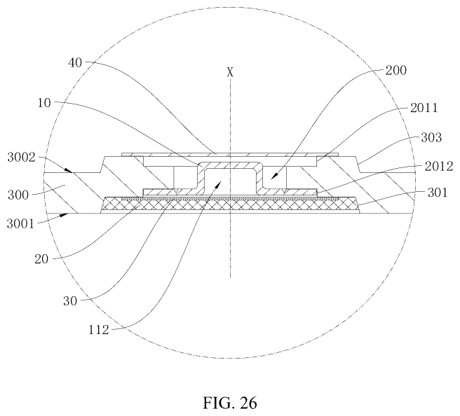

Referring to FIGS. 17 and 26, the injection hole sealing structure 100 further includes an anti-adhesive piece 30, and the anti-adhesive piece 30 is disposed between the sealing cover 20 and the sealing member 10. By an arrangement of the anti-adhesive piece 30, the phenomenon that an adhesive leaks to the removal portion 1002 to influence the break when the sealing cover 20 is adhered on the cover plate 300 or the remaining portion 1003 can be prevented. In particular, a diameter of the anti-adhesive piece 30 is greater than a largest outer diameter of the removal portion 1002, so as to ensure a sufficient protection area.

Referring to FIGS. 23 to 26, optionally, the injection hole sealing structure 100 further includes a protective piece 40, and the protective piece 40 is arranged on the side of the sealing member 10 towards outside of the battery. By an arrangement of the protective piece 40, a protection effect for the sealing member 10 can be provided, and the phenomenon that the sealing member 10 damaged by the external force during the secondary injection can be prevented, thereby ensuring the sealing stability of the injection hole sealing structure 100.

When the connecting portion 12 is entirely located in the first platform 2011, and the force applying portion 11 protrudes towards the inside of the battery, the protective piece 40 can be arranged on the outside 3002 of the cover plate 300 and covers the first platform 2011.

Referring to FIG. 23, the protective piece 40 can be located in the convex ring 305, and the convex ring 305 can play a role of a fence of the protective piece 40, thereby improving a protection of the protective piece 40.

Referring to FIGS. 24 and 26, in actual use, the protective piece 40 is connected to the cover plate 300. Along a direction towards the outside of the battery from the injection hole 200, when a downstream side of the sealing member 10 is located downstream of the cover plate 300, a third step 303 is provided downstream of the cover plate 300, the third step 303 protrudes towards the outside of the battery around the injection hole 200, a downstream side of the third step 303 is located on the downstream of the sealing member 10, and the protective piece 40 is disposed on the side of third step 303 towards the outside of the battery. By an arrangement of the third step 303, the protective piece 40 is located downstream of the overall sealing member 10 along a direction towards the outside of the battery from the injection hole 200, so as to prevent an interference between the protective piece 40 and the sealing member 10.

In particular, the downstream side of the sealing member 10 and the downstream of the cover plate 300 are defined by a direction of the injection hole 200 towards the outside of the battery.

In some embodiments, when the cavity 112 is defined by the side of the sealing member 10 towards the outside of the battery recessing towards the inside of the battery, the cavity 112 and the connecting hole 114 can be a same structure.

The present disclosure provides a battery. The battery includes a battery shell and a cover plate 300 connected to the battery shell, the injection hole 200 is defined on one of the battery shell and the cover plate 300, and the injection hole sealing structure 100 is installed on the injection hole 200. In some embodiments, the injection hole 200 is defined on the cover plate 300.

The specific way of defining the injection hole 200 on the battery shell or the cover plate 300 has been illustrated above, which is not described herein.

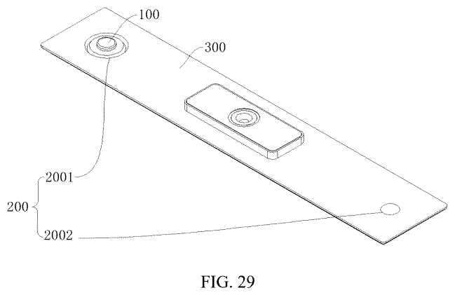

Referring to FIG. 29, the number of injection holes 200 can be defined at least two, the at least two injection holes 200 are disclosed at interval. Meanwhile, the above injection hole sealing structure 100 is installed on at least one of the at least two injection holes 200. For example, a first injection hole 2001 and a second injection hole 2002 are defined on the cover plate 300, the first injection hole 2001 and the second injection hole 2002 are disposed at interval along a length direction of the cover plate 300, respectively. In particular, the injection hole sealing structure 100 is installed on the first injection hole 2001, which is configured for the secondary injection. The second injection hole 2002 can be configured for a first injection and sealed after the first injection. Alternatively, a plurality of injection hole sealing structures 100 can be installed on the first injection hole 2001 and the second injection hole 2002. The plurality of injection hole sealing structures 100 can be configured to inject liquid during the battery production process. Alternatively, the quantity of injection holes 200 can be three or four, or more.

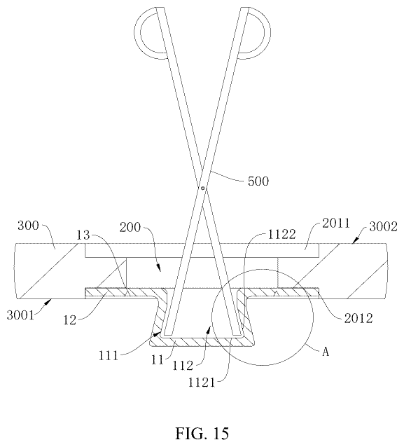

Referring to FIGS. 15 to 17, 27 and 28, the present disclosure further provides a secondary injection method. The secondary injection method includes the following steps: the force applying portion 11 is applied a force to cause the battery to break at the sealing member 10, so as to form an opening 1001 for the secondary injection. The secondary injection is performed on the battery at the opening 1001 and the opening 1001 is sealed after the secondary injection.

In particular, pliers tools or other external tools can be acted on the exertion segment 111 of the force applying portion 11, and be cooperated with the force applying portion 11 by clamping or inflating. Then, the pliers tools or other external tools can be pulled towards the outside of the battery, such that the sealing member 10 is broken to form the opening 1001. If the force applying portion 11 protrudes towards the inside of the battery, the broken force applying portion 11 is taken from the break opening 1001 and prevented from falling in the battery. Then, a fill port of a secondary injection tool aligns with the above opening 1001 to introduce the electrolyte into the battery cavity. After the electrolyte is adequately filled, the secondary injection tool is removed, and the opening 1001 is sealed. Such an arrangement is conducive to performing.

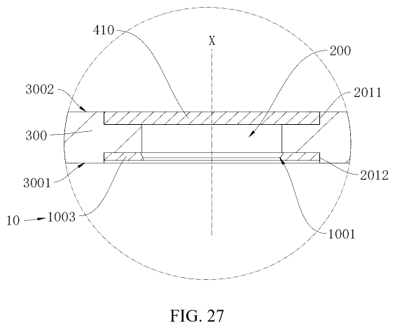

Referring to FIG. 27, when the opening 1001 is sealed, a sealing piece 410 can be weld at an end of the opening 1001 away from the battery cavity. By welding, a good fixing effect for the sealing piece 410 corresponding to the battery and a good sealing performance on a connecting portion between the opening 1001 and the sealing piece 410 can be ensured, the phenomenon that a leakage due to inadequate sealing after the secondary injection should be avoided as far as possible.

In particular, a size of the sealing piece 410 is greater than a size of the opening 1001. Referring to FIGS. 14, 17 and 27, when the first platform 2011 is provided on the outside 3002 of the cover plate 300 and the second platform 2012 is provided on the inside 3001 of the cover plate 300, the connecting portion 12 is integrally connected to the second platform 2012. The sealing piece 410 is arranged on the first platform 2011 and fixed on a side wall of the first platform 2011. Alternatively, the connecting portion 12 is integrally connected to the first platform 2011, a size of the sealing piece 410 is greater than a size of the connecting portion 12, so as to arrange the sealing piece on a side wall of the connecting portion 12 towards the outside of the battery and fix it on the cover plate 300 by welding.

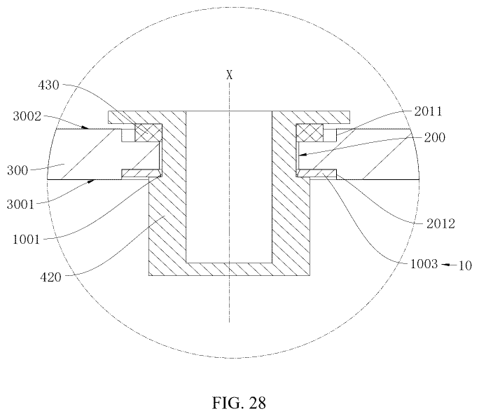

Referring to FIG. 28, alternatively, when the opening 1001 is sealed, a sealing plug 420 is inserted into the opening 1001 and is riveted to seal the opening 1001. In actual use, a sealing ring 430 can be pressed between the cover plate 300 and the sealing plug 420. In particular, the sealing plug 420 is inserted into the opening 1001, the sealing ring 430 is sleeved on the outside of the sealing plug 420, an end of the sealing plug 420 towards the outside of the battery protrudes from the sealing ring 430 along a radial direction of the injection hole 200, and at least one side of the sealing ring 430 is located in the first platform 2011 along a thickness of the sealing ring 430. Then, the sealing plug 420 can deform under the external force, a part of the sealing plug 420 located out of the battery is arranged on an end surface of the sealing ring 430 towards the outside of the battery, thus the sealing ring 430 is compressed between the sealing plug 420 and the first platform 2011, which is sealed between the cover plate 300 and the sealing plug 420 by the sealing ring 430. For example, the sealing plug 420 can use a rivet nut with an sealed end and an opened end, in which the opened end of the blind rivet is towards the outside of the battery and compresses the sealing ring 430.

In some embodiments, before the opening 1001 is sealed, it is required to polish an edge of the opening 1001, so as to make the edge of the opening 1001 flat and remove burrs after the break and so on. Then, dust and impurities generated during a polishing process are cleaned. Alternatively, during the polishing process, cleaning is processed at the same time.

The various technical features of the above embodiments can be combined in any way. To make the description concise, all possible combinations of the various technical features in the above embodiments have not been described. However, as long as there is no contradiction in the combinations of these technical features, they should be considered within the scope of this specification.

The above embodiments only express several embodiments of the present disclosure, and their description is more specific and detailed, but cannot be understood as a limitation on the scope of the present disclosure. It should be pointed out that, for those ordinary skilled in the art, several modifications and improvements can be made without departing from a concept of the present disclosure, all of which fall within the scope of protection of the present disclosure. Therefore, the scope of patent protection in the present disclosure shall be based on claims.

What is claimed is:

1. An injection hole sealing structure, comprising:
a sealing member configured to seal an injection hole of a battery, wherein the sealing member is integrally connected to a part of the battery where the injection hole is located, and the sealing member comprises a force applying portion for applying an external force to cause the sealing member to break.

2. The injection hole sealing structure of claim 1, wherein the sealing member further comprises a connecting portion connected to the force applying portion and the force applying portion is integrally connected to the part of the battery where the injection hole is located through the connecting portion.

3. The injection hole sealing structure of claim 2, wherein the force applying portion protrudes from the connecting portion.

4. The injection hole sealing structure of claim 3, wherein the injection hole has an axis and the force applying portion protrudes towards outside or inside of the battery from the connecting portion along the axis of the injection hole.

5. The injection hole sealing structure of claim 4, wherein a cavity is formed on a side of the force applying portion along the axis of the injection hole;
when the force applying portion protrudes towards the outside of the battery from the connecting portion, the cavity is formed by a side of the sealing member towards inside of the battery recessing towards the outside of the battery; when the force applying portion protrudes towards the inside of the battery from the connecting portion, the cavity is formed by a side of the sealing member towards outside of the battery recessing towards the inside of the battery.

6. The injection hole sealing structure of claim 2, wherein the injection hole has an axis, and along the axis of the injection hole, at least a segment of the force applying portion is defined as an exertion segment for cooperation with an external tool;
the force applying portion protrudes towards the outside of the battery from the connecting portion, and an outer size of the exertion segment gradually increases towards the outside of the battery from the connecting portion; or, the exertion segment protrudes towards the inside of the battery from the connecting portion, the cavity is defined at a side of the sealing member towards the outside of the battery, at least part of the cavity is located at the exertion segment, and an inner size of the exertion segment gradually increases towards the inside of the battery from the connecting portion.

7. The injection hole sealing structure of claim 1, wherein the force applying portion is provided with a connecting hole with an opening facing outside of the battery, and a hole wall of the connecting hole is provided a threaded structure.

8. The injection hole sealing structure of claim 1, wherein the sealing member further comprises:
a connecting portion encircling and connected to the force applying portion, and the connecting portion is integrally connected to the part of the battery where the injection hole is located; and
a weakened portion provided on the connecting portion or the force applying portion or at a joint of the connecting portion and the force applying portion, or on both the connecting portion and the force applying portion; the weakened portion is capable of being broken in response to the external force applied to the force applying portion.

9. The injection hole sealing structure of claim 1, wherein the weakened portion encircles a location where it is placed.

10. The injection hole sealing structure of claim 8, wherein the injection hole has an axis, along the axis of the injection hole, at least a part of the force applying portion is constructed as an exertion segment; and along a direction towards the exertion segment from the connecting portion, the weakened portion is located on a upstream of the exertion segment.

11. The injection hole sealing structure of claim 8, wherein a part of the seal member removed after being broken through the weakened portion is defined as a removal portion;
the force applying portion protrudes from the connecting portion towards inside of the battery, and/or, the sealing member is integrally connected to the part of the battery where the injection hole is located towards inside of the battery; a maximum outer size of the removal portion along a radial direction of the injection hole is less than or equal to a diameter of the injection hole.

12. The injection hole sealing structure of claim 1, wherein the injection hole has an axis, and a recessed groove is provided on at least one end of the part of the battery where the injection hole is located along the axis of the injection hole, and a portion of the sealing member is accommodated in the recessed groove.

13. The injection hole sealing structure of claim 1, further comprising a sealing cover, wherein the sealing cover is disposed on one side of the sealing member facing inside of the battery.

14. The injection hole sealing structure of claim 13, wherein the sealing cover is connected to the part of the battery where the injection hole is located towards the inside of the battery; or, after the seal member being broken, a portion connected to the part of the battery where the injection hole is located is defined as a remaining portion, the sealing cover is connected to the remaining portion, and the sealing cover is configured to cover a broken part of the sealing member.

15. The injection hole sealing structure of claim 13, wherein one of the part of the battery where the injection hole is located and the sealing cover has a slot, and the other of the part of the battery where the injection hole is located and the sealing cover has a protrusion for engaging the slot;
and/or, the sealing cover is adhered to the part of the battery where the injection hole is located;
the injection hole sealing structure further comprises an anti-adhesive piece, wherein the anti-adhesive piece is disposed between the sealing cover and the sealing member.

16. The injection hole sealing structure of claim 13, wherein the part of the battery where the injection hole is located is provided with a first step, the first step is concave towards outside of the battery from the sealing cover, the sealing cover is located on the first step;
the first step is concave towards the outside of the battery from a bottom surface of the part of the battery where the injection hole is located; or, a second step is provided on a bottom surface of the part of the battery where the injection hole is located, the second step protrudes towards the inside of the battery from the sealing cover, the first step is concave towards the outside of the battery from a protruding end surface of the second step, the first step and the second step both surround the injection hole, and the second step surrounds the first step.

17. The injection hole sealing structure of claim 1, further comprising a protective piece, wherein the protective piece is arranged on one side of the sealing member facing outside of the battery.

18. The injection hole sealing structure of claim 17, wherein the protective piece is connected to the part of the battery where the injection hole is located; and
along a direction towards the outside of the battery from the injection hole, when a downstream side of the sealing member is located downstream of the part of the battery where the injection hole is located, a third step is provided downstream of the part of the battery where the injection hole is located, the third step protrudes towards the outside of the battery around the injection hole, a downstream side of the third step is located on the downstream of the sealing member, and the protective piece is disposed on the third step.

19. A battery, comprising a battery shell and a cover plate connected to the battery shell;
the battery shell, the cover plate, or both the battery shell and the cover plate are provided with an injection hole, and the injection hole sealing structure of claim 1 is installed at the injection hole.

20. The battery of claim 19, wherein the number of the injection hole is at least two, and at least one of the at least two injection holes is installed with the injection hole sealing structure.

21. A secondary injection method based on the injection hole sealing structure of claim 1, wherein the secondary injection method comprises the following steps:
operating the force applying portion of the injection hole sealing structure to cause the battery to break at the sealing member to form an opening for secondary injection; and
performing a secondary injection on the battery at the opening and sealing the opening after the secondary injection.

22. The secondary injection method of claim 21, wherein sealing the opening further comprises: welding a sealing piece to seal the opening, or inserting a sealing plug into the opening and then riveting to seal the opening.
